(19) United States
(12) Patent Application Publication
(10) Pub. No.: US 2009/0057423 A1
(43) Pub. Date: Mar. 5, 2009

(54) CASH PROCESSING MACHINE

(75) Inventors: Hiroshi NOBUHARA, Himeji-shi (JP); Yasuharu IWATA, Himeji-shi (JP); Takashi MAEDA, Himeji-shi (JP)

Correspondence Address: DARBY & DARBY P.C., P.O. BOX 770, Church Street Station, New York, NY, 10008-0770, US

(73) Assignee: Glory Ltd., Himeji-shi (JP)

(21) Appl. No.: 12/199,774

(22) Filed: Aug. 27, 2008

(30) Foreign Application Priority Data
Sep. 3, 2007 (JP) 2007-228237
Sep. 3, 2007 (JP) 2007-228238
Sep. 3, 2007 (JP) 2007-228239
Sep. 3, 2007 (JP) 2007-228240

(51) Int. Cl. G07G 1/00; F21V 33/00; G06F 17/00

(52) U.S. Cl. 235/7 A; 362/253; 235/375

(57) ABSTRACT

This invention provides a coin depositing and dispensing machine capable of clearly specifying whether each coin dispensed into the same coin dispensing port is a coin to be paid or rejected coin, and preventing the coins from being mistakenly mishandled. Light emitting unit capable of emitting light of different colors is disposed in the vicinity of the coin dispensing port. The light emitting unit emits a green light if the coin dispensed into the coin dispensing port is a coin to be paid, and emits a red light if the dispensed coin is a rejected coin. The light emitting unit irradiates light to the whole coin dispensing port and the coins themselves in the coin dispensing port. When the coins are taken out from the coin dispensing port, it can be recognized whether the coin is a coin to be paid or rejected coin.

### INCORPORATION BY REFERENCE

The present invention claims priority under 35 U.S.C. §119 to Japanese Patent Application Nos. 2007-228237, 2007-228238, 2007-228239 and 2007-228240 all filed on Sep. 3, 2007. The content of the applications are incorporated herein by reference in their entirety.

### FIELD OF THE INVENTION

The present invention relates to a cash processing machine in which different handling types of cash containing cash to be paid and rejected cash at least are dispensed into the same cash dispensing port.

### BACKGROUND OF THE INVENTION

Conventionally, a cash processing machine, into which coins or banknotes can be automatically deposited and which can automatically dispense them, by control signals transmitted from a POS cash register, an electronic cash register, a teller management machine or other cashier equipment, has been developed for accurately and promptly delivering money between clerks in charge and customers at, for example, a cash register in a shop or a teller in a financial institution.

For example, in a cash processing machine disclosed in Japanese Laid-Open Patent Publication No. 2001-43449, a cash slot, into which cash to be deposited is put, an operating portion and a display portion are disposed in an upper face of the front of a machine body, and one cash dispensing port, into which cash to be paid, rejected cash and the like are dispensed, is disposed in the front of the machine body. That is, the cash to be paid, and the rejected cash, which is eliminated by identification of the deposited cash put into the cash slot, are dispensed into the same cash dispensing port.

Additionally, there is a cash processing machine which has a display portion for displaying the rejected cash in the case where the rejected cash is dispensed into the cash dispensing port.

However, since the cash to be paid and the rejected cash are dispensed into the same cash dispensing port, it is impossible to decide whether the cash dispensed into the cash dispensing port is cash to be paid or rejected cash other than the cash to be paid, even if the dispensed cash is looked at. Therefore, there is a possibility that the cash to be paid and the rejected cash are mistakenly mishandled.

Additionally, regarding the cash processing machine which has a display portion for displaying the rejected cash in the case where the rejected cash is dispensed into the cash dispensing port, the clerk in charge frequently overlooks the display portion, and looks and handles only the cash dispensed into the cash dispensing port.

The present invention is made in view of the above problems, and aims at providing a cash processing machine capable of clearly specifying the handling type of the cash dispensed into the same cash dispensing port and preventing the cash from being mistakenly mishandled.

### SUMMARY OF THE INVENTION

A cash processing machine of the present invention, in which different types of cash containing cash to be paid and rejected cash at least are dispensed into the same cash dispensing port, includes light emitting unit which is provided in the vicinity of the cash dispensing port and capable of emitting light in different light emission forms, and control unit for making the light emitting unit emit light in a different light emission form for each handling type of the cash dispensed into the cash dispensing port. Since light is thus emitted, by the light emitting unit provided in the vicinity of the cash dispensing port, in a different light emission form for each handling type of the cash dispensed into the cash dispensing port, the handling type of the cash dispensed into the same cash dispensing port can be clearly recognized, and the cash can be prevented from being mistakenly mishandled.

Additionally, in the cash processing machine of the present invention, the light emitting unit can emit light of different colors as light emission forms, and the control unit makes the light emitting unit emit light having a different color for each handling type of the cash dispensed into the cash dispensing port. Since light having a different color for each handling type of the cash dispensed into the cash dispensing port is thus emitted by the light emitting unit, the handling type of the cash can be clearly recognized based on the color of the light.

Additionally, in the cash processing machine of the present invention, the light emitting unit irradiates light to the cash itself dispensed into the cash dispensing port. Since the light emitting unit thus irradiates the light to the cash itself dispensed into the cash dispensing port, the handling type of the cash can be clearly recognized when taking the cash out from the cash dispensing port.

Additionally, in the cash processing machine of the present invention, the light emitting unit irradiates light to the whole cash dispensing port. Since the light emitting unit thus irradiates the light to the whole cash dispensing port, the handling type of the cash can be clearly recognized in taking out the cash from the cash dispensing port.

Additionally, in the cash processing machine of the present invention, the control unit makes the light emitting unit turn on when the cash is dispensed into the cash dispensing port, and makes the light emitting unit flash after a lapse of a predetermined time from the turning-on. Since the control unit thus makes the light emitting unit turn on when the cash is dispensed into the cash dispensing port, and thus makes it flash after a lapse of the predetermined time from the turning-on, it is clearly indicated that the cash is dispensed into the cash dispensing port, and forgetting to take out the cash can be prevented.

Additionally, in the cash processing machine of the present invention, the control unit makes the light emitting unit flash in the case where the cash dispensed into the cash dispensing port is rejected cash. Since the control unit thus makes the light emitting unit flash in the case where the cash dispensed into the cash dispensing port is rejected cash, it can be clearly recognized the cash dispensed into the cash dispensing port is rejected cash.

Additionally, in the cash processing machine of the present invention, error return cash is also contained in the different handling types of cash dispensed into the same cash dispensing port, and the control unit makes the light emitting unit emit light in different light emission forms in the cases where the cash dispensed into the cash dispensing port is cash to be paid, rejected cash and error return cash. Since the control unit thus makes the light emitting unit emit light in a different light emission form for each different handling type of the cash dispensed into the cash dispensing port even in the case where the error return cash is contained in the different handling types of the cash dispensed into the same cash dispensing port, the handling type of the cash dispensed into the same cash dispensing port can be clearly recognized, and the cash can be prevented from being mistakenly mishandled.

### BRIEF DESCRIPTION OF THE DRAWINGS

FIG. 1 is a perspective view of a coin depositing and dispensing machine according to an embodiment of the cash processing machine of the present invention.

FIG. 2 is a cross sectional view of the vicinity of a coin dispensing port of the coin depositing and dispensing machine.

FIG. 3 is a plan view showing an inner structure of the coin depositing and dispensing machine.

FIGS. 4(a) to 4(d) each is a plan view showing operation of delivering unit of the coin depositing and dispensing machine.

FIG. 5 is a perspective view explaining attachment/detachment operation of a rejection box of the coin depositing and dispensing machine.

FIG. 6 shows the inner structure of the coin depositing and dispensing machine, FIG. 6(a) is a side view of the non-attached rejection box, and FIG. 6(b) is a side view of the attached rejection box.

FIG. 7 is a cross sectional view of an accommodating and ejecting portion of the coin depositing and dispensing machine.

FIG. 8 is a block diagram of a constitution relevant to management of the cash quantity of the accommodating and ejecting portion.

FIG. 9 is an explanatory diagram relevant to the management of the cash quantity of the accommodating and ejecting portion.

FIG. 10 is a flow chart for checking whether the rejection box is attached/detached in accordance with setting of a mode of the coin depositing and dispensing machine.

FIG. 11 indicates operation of the coin depositing and dispensing machine, FIG. 11(a) is a flow chart for starting of a depositing process, and FIG. 11(b) is a flow chart of a replenishment process.

FIG. 12 is a table indicating operation of each constitution according to each state of the cash quantity of the accommodating and ejecting portion of the coin depositing and dispensing machine.

FIG. 13 is a flow chart of a collecting process of the coin depositing and dispensing machine.

### DETAILED DESCRIPTION OF THE PREFERRED EMBODIMENT

Hereinafter, an embodiment of the present invention will be described with reference to the drawings.

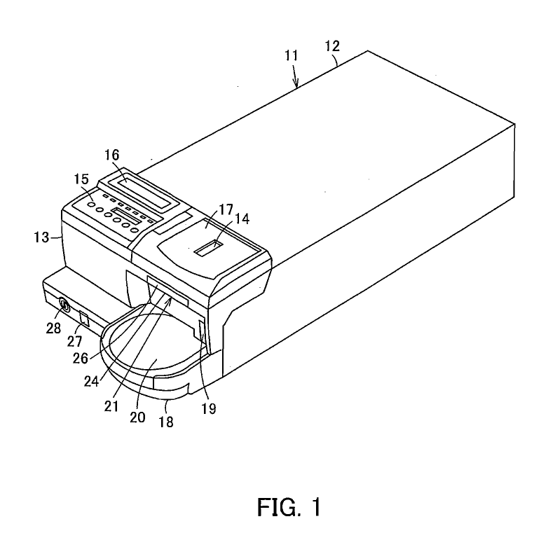

FIG. 1 is a perspective view of a coin depositing and dispensing machine as a cash processing machine. The coin depositing and dispensing machine is a coin depositing and dispensing machine which communicates with a POS cash register and makes depositing and dispensing coins as cash possible at, for example, a cash register in a shop.

A machine body 11 of the coin depositing and dispensing machine includes a frame body 12 having an opened front face, and a body unit 13 capable of being pulled out from the front face of the frame body 12. The dimension of the front face of the body unit 13 in a machine body width direction is formed so as to be approximately half of that of the POS cash register, and the coin depositing and dispensing machine can be used in combination with, for example, a banknote depositing and dispensing machine having a width the same as that thereof.

A coin slot 14, into which coins are put, is formed on the right side, which is one side in the machine body width direction, of an upper face of the front of the body unit 13 projecting from the frame body 12. An operating portion 15 and a display portion 16 are disposed on the left side which is the other side in the machine body width direction, the operating portion 15 having operating and setting buttons, the display portion 16 including a liquid crystal display for displaying each item relating to operation, setting and the like, and an LED display for displaying the denomination-specific accommodated coin quantity. The coin slot 14 is formed in an openable/closable cover 17.

A dispensing tray 18 is projected on a lower part on the right side of the front face of the body unit 13, and a coin dispensing port 20 is formed on an upper face of the dispensing tray 18, the port 20 being a cash dispensing port into which coins to be dispensed from the machine are released through a coin release port 19. A full detecting sensor (not shown) for optically detecting a full state, where the coin dispensing port 20 is filled with the dispensed coins, is disposed on the dispensing tray 18.

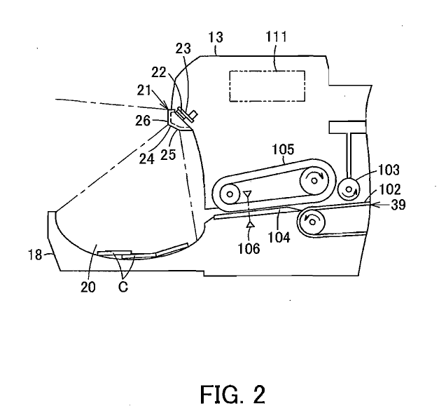

Light emitting unit 21 is disposed on the front face of the body unit 13 located above the coin dispensing port 20, the light emitting unit 21 emitting light in a different light emission form for each handling type of coins such as a coin to be paid, rejected coin and error return coin dispensed into the coin dispensing port 20. The light emitting unit 21, as shown in FIG. 2, includes an LED 22 as a light emitting portion capable of emitting light of at least two different colors, and a substrate 23, on which the LED 22 is mounted, is obliquely provided so that the LED 22 faces the coin dispensing port 20. The light emitting unit 21 is covered with a lens 24. The lens 24 includes: a coin dispensing port irradiating lens portion 25, which is obliquely formed so as to face the coin dispensing port 20 and irradiates light emitted from the LED 22 to the whole coin dispensing port 20 and coins (indicated by a symbol C in figures, the symbol will be omitted hereinafter) themselves dispensed into the coin dispensing port 20; and a forward irradiating lens portion 26 which is formed on the front face so as to face forward and irradiates the light emitted from the LED 22 forward.

Additionally, as shown in FIG. 1, a power source switch 27 of the coin depositing and dispensing machine and a key 28 are disposed on the left side of the front face of the body unit 13, the key 28 for locking with the unit 13 inserted in the frame body 12.

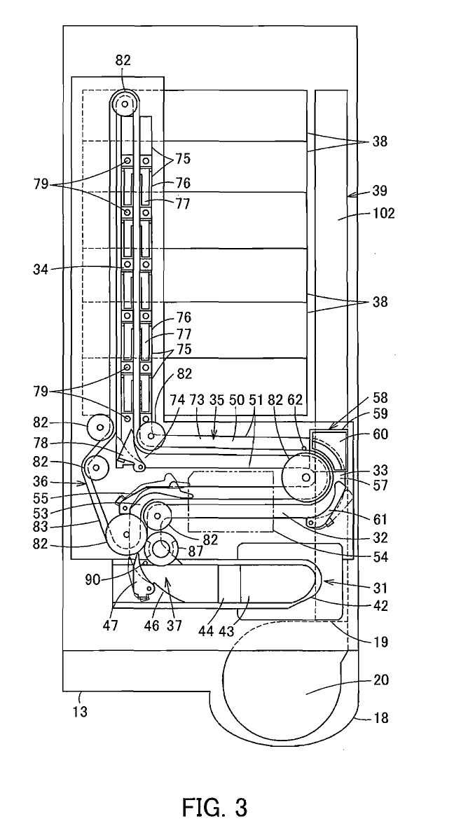

FIG. 3 is a plan view showing an inner structure of the coin depositing and dispensing machine. The coin depositing and dispensing machine includes: a feeding mechanism 31 disposed along the front of the machine body 11 along the machine body width direction; a coin passage 35 having an identifying passage 32 disposed continuously to the feeding mechanism 31 in the machine body width direction, an eliminating passage 33 disposed continuously to the identifying passage 32 in a machine body depth direction, and a sorting passage 34 disposed continuously to the eliminating passage 33 in the machine body depth direction; transporting unit for depositing 36 for transporting coins in the coin passage 35; delivering unit 37 for delivering coins fed from the feeding mechanism 31 to the transporting unit for depositing 36 one by one; accommodating and ejecting portions 38 as denomination-specific coin accommodating portions juxtaposed under the sorting passage 34 in the machine body depth direction; and transporting unit for dispensing 39 disposed adjacently to the right sides of the accommodating and ejecting portions 38, and in a longitudinal direction along a right side face of the machine body 11.

The feeding mechanism 31 has a receiving and accommodating portion 42 under the coin slot 14, the receiving and accommodating portion 42 for receiving and accommodating coins put into the coin slot 14 with the coins not aligned, and a feeding belt 43 constituting a bottom of the receiving and accommodating portion 42 is disposed along the machine body width direction. The feeding belt 43 is an endless flat belt, transports the coins from the right side to left side of the machine body in a coin feeding direction, and is suspended by a plurality of rollers (not shown) so that an upward tilting region is formed at the upstream side in the feeding direction toward the downstream side in the feeding direction and a horizontal region is formed at the downstream side in the feeding direction. The width of a passage on the feeding belt 43 is regulated so as to be larger than the diameter of the largest coin to be processed and smaller than the total diameters of the two smallest coins to be processed.

A reverse rotating roller 44 is disposed across a gap, through which only one coin can pass in its thickness direction, from the upper side of the upward tilting region of the feeding belt 43. The reverse rotating roller 44 rotates in a direction reversely to the coin feeding direction of the feeding belt 43, and aligns and feeds non-aligned coins, which are to be fed by rotation of the feeding belt 43 in the coin feeding direction, on the feeding belt 43 by one layer and one line.

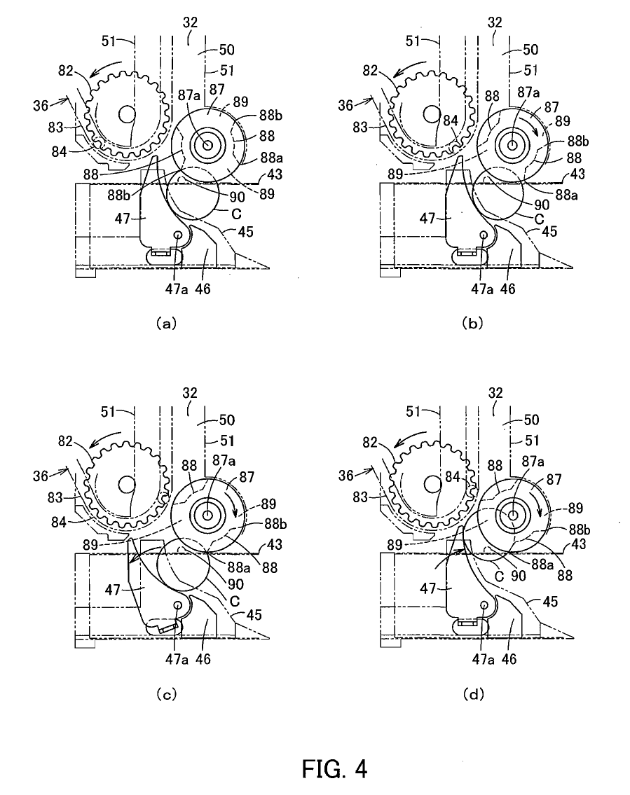

As shown in FIG. 4, a regulating member 45 is disposed across a gap, in which only one coin can enter between the member 45 and the feeding belt 43 in the thickness direction, from the upper side of the horizontal region at the downstream side of the feeding belt 43 in the feeding direction. A guide portion 46 is disposed on the lower side of the regulating member 45, the guide portion 46 with which the circumference of the coin on the feeding belt 43 comes into contact and which guides the coin to the starting end side of the identifying passage 32, and a part, which faces a feeding position to the starting end side of the identifying passage 32, of the guide portion 46 is constituted by a pulling-over lever 47 for pulling coins to be fed to the identifying passage 32 over to the inner side of the passage. The pulling-over lever 47 constitutes a part of the delivering unit 37, can rock about a shaft 47a as a fulcrum in a passage inner and outer direction, and is energized by a spring (not shown) as energizing unit so as to rock to the inner side of the passage.

Additionally, as shown in FIG. 3, the coin passage 35 running through the identifying passage 32, eliminating passage 33 and the sorting passage 34 has a passage face 50 constituted by a horizontal face with which one face of the coin comes into contact, and passage side guides 51 for guiding the circumference of the coin at both sides of the passage face 50. A passage width that is a facing width of both the passage side guides 51 is formed so as to be larger than the diameter of the largest coin to be processed and smaller than the total diameters of the two smallest coins to be processed.

The identifying passage 32 is disposed, inside relative to the feeding mechanism 31, in parallel with the feeding belt 43 of the feeding mechanism 31 via a first turn passage portion 53 turning in a right direction from the starting end connected to the feeding position of the feeding mechanism 31. An identifying portion 54 for detecting the material quality, diameter and the like of a coin and identifying a denomination is disposed at the identifying passage 32. A pulling-over lever 55 for pulling coins over to one side in a passage width direction is rockably pivotally supported on the first turn passage portion 53 and energized so as to rock to the inner side of the passage, in order to make the identifying portion 54 stably identify coins.

Additionally, the eliminating passage 33 is formed in a second turn passage portion 57 continuing to the identifying passage 32 and turning in a left direction of the machine body, and a rejecting portion 58 is disposed aside of the eliminating passage 33, the rejecting portion 58 for eliminating coins rejected as a result of identification of the identifying portion 54. A rejection hole 59 is formed in the rejecting portion 58, the rejection hole 59 having a diameter that the coin can be diverged throughout a portion from the passage face 50 to the passage side guide 51 on the outer circumferential side of the second turn passage portion 57, and a rejecting gate 60 is arranged over the rejection hole 59, the rejecting gate 60 serving as a part from the passage face 50 to the passage side guide 51 on the outer circumferential side of the second turn passage portion 57. The rejecting gate 60 rocks upward from the passage about its machine body back side as a fulcrum, can open/close between an open position for eliminating the rejected coins, which are transported from the identifying passage 32 side, through the rejection hole 59, and a close position for closing the rejection hole 59 and permitting passage of the coins from the identifying passage 32 to the sorting passage 34, and is open/close-driven by electric driving unit such as a solenoid or motor (not shown).

A pulling-over lever 61 for pulling coins over to one side in a passage width direction is pivotally supported on the second turn passage portion 57 and energized to rock to the inside of the passage, so that the rejected coins are reliably eliminated by the rejecting portion 58.

A coin detecting sensor 62 for detecting passage of coins is disposed at the downstream side from the rejecting portion 58 in a transporting direction.

Moreover, as a coin to be eliminated by the rejecting portion 58, an error return coin and the like are contained in addition to the rejected coin.

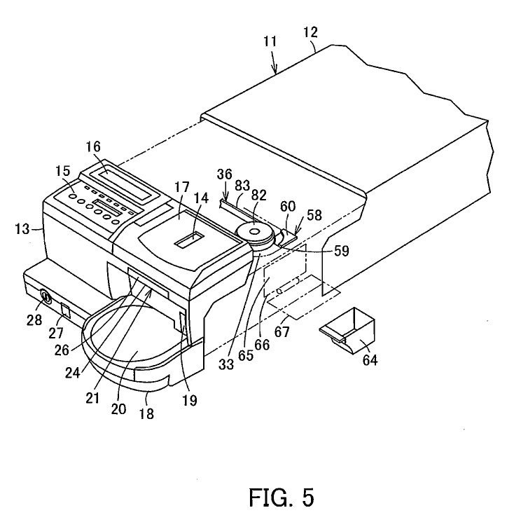

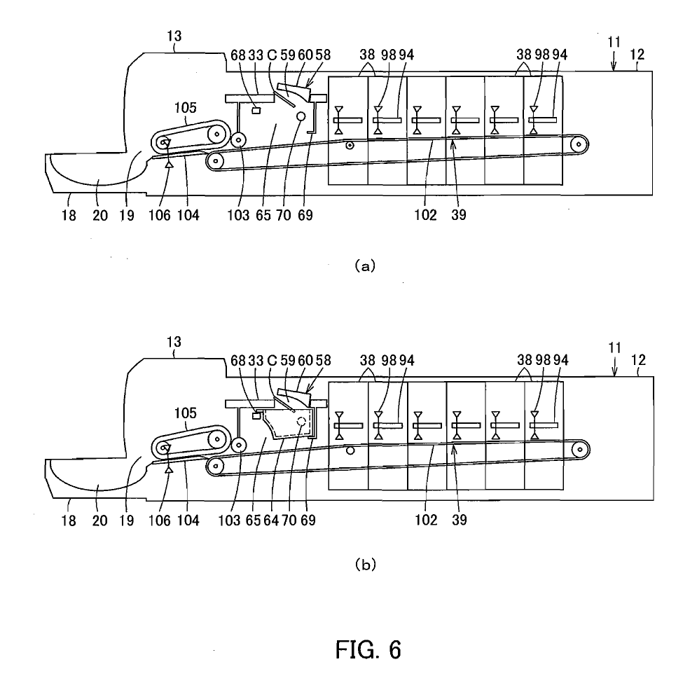

Additionally, as shown in FIGS. 5 and 6, a rejection box attaching portion 65, to/from which a rejection box 64 can be attached/detached, is formed under the rejection hole 59 of the rejecting portion 58.

The rejection box 64 is formed in the shape of a box having an opened upper face, and can be attached/detached through an attachment/detachment port 66, which is made in a side face of the rejection box attaching portion 65, with the body unit 13 pulled forward from the frame body 12. The attachment/detachment port 66 can be opened/closed by a cover 67.

The rejection box attaching portion 65 has a front side supporting portion 68 for supporting the front end edge of the rejection box 64, and a rear side supporting portion 69 for supporting a lower face at the rear of the rejection box 64, a space between the front side supporting portion 68 and rear side supporting portion 69 is opened downward, and the transporting unit for dispensing 39 is disposed under the supporting portions so as to face them. That is, the transporting unit for dispensing 39 is disposed under the rejection hole 59 of the rejecting portion 58, and the rejection box 64 is arranged attachably/detachably into/from a space between the rejection hole 59 of the rejecting portion 58 and the transporting unit for dispensing 39.

As shown in FIG. 6(a), the transporting unit for dispensing 39 receives the rejected coins eliminated from the rejecting portion 58 to dispense them into the coin dispensing port 20 by not attaching the rejection box 64 to the rejection box attaching portion 65. Additionally, as shown in FIG. 6(b), the rejected coins eliminated from the rejecting portion 58 are accommodated in the rejection box 64 by attaching the rejection box 64 to the rejection box attaching portion 65.

Rejection box detecting unit 70 for detecting whether the rejection box 64 is attached is disposed in the rejection box attaching portion 65.

Additionally, as shown in FIG. 3, the sorting passage 34 is disposed so as to pass through a left side region above the accommodating and ejecting portions 38 in the machine body depth direction via a connecting passage 73 leading from the eliminating passage 33 to the left side of the machine body and a direction changing passage 74 leading from the connecting passage 73 to the rear side of the machine body. A plurality of sorting portions 75 are disposed, the sorting portions 75 sorting coins by denomination at a plurality of sorting positions, which respectively correspond to positions above the plurality of accommodating and ejecting portions 38, and making each accommodating and ejecting portion 38 accommodate the sorted coins. In each sorting portion 75, a sorting hole 76 for dropping the coins is opened and formed in the passage face 50, and a sorting gate 77 is disposed at each sorting hole 76 except for the sorting hole 76 located at the most downstream side in the transporting direction. Each sorting gate 77 rocks, upward from the passage, about its downstream side in the coin transporting direction as a fulcrum, can be opened/closed between an open position of dropping the coins, which are transported from the upstream side of the sorting passage 34 in the transporting direction, into the sorting hole 76, and a close position for closing the sorting hole 76 and permitting passage of the coins to the downstream side of the sorting passage 34 in the transporting direction, and open/close-driven by electric driving unit such as a solenoid or motor (not shown). No sorting gate is disposed at the sorting hole 76 located at the most downstream side in the transporting direction, and the hole is opened.

A pulling-over lever 78 for pulling coins over to one side in a passage width direction is pivotally supported on the direction changing passage 74 and energized so as to rock to the inner side of the passage, so that the coins are reliably sorted by each sorting portion 75.

A coin detecting sensor 79 for detecting coins to be transported is disposed at the upstream side from each sorting portion 75 of the sorting passage 34 in the transporting direction so that an open/close timing of the sorting gate 77 is set and sorting of coins for each accommodating and ejecting portion 38 is checked.

Additionally, a transporting belt 83 as a transporting body is stretched in the transporting unit for depositing 36 so as to rotate while moving along center regions of the identifying passage 32, eliminating passage 33 and sorting passage 34 in the passage width direction by a plurality of pulleys 82 each as a rotation body pivotally supported on a vertical shaft so as to be horizontally rotatable. As the transporting belt 83, for example, a timing belt having a plurality of teeth on its inner circumference is used. In this case, as the pulley 82, a timing pulley having a plurality of teeth on its circumferential face is used. The distance of an interval between the transporting belt 83 supported by the plurality of pulleys 82 and the passage face 50 is kept larger than the thickness of a coin having a maximum thickness to be processed.

Projected portions 84 (see FIG. 4), which project downward and press and transport the coins in the passage one by one, are provided on the transporting belt 83 at a predetermined interval so that the coins can be separated and transported one by one in the transporting direction. The distance of an interval between the projected portion 84 and the passage face 50 is kept smaller than the thickness of a coin having a minimum thickness to be processed.

Additionally, as shown in FIG. 4, the delivering unit 37 is disposed at the starting end, from which the coins fed from the feeding mechanism 31 are received onto the identifying passage 32, of the identifying passage 32, and has the pulling-over lever 47 for guiding the coins from the upper face of the feeding belt 43 to the identifying passage 32, and a circular cam 87 which is provided on the side opposite from the pulling-over lever 47 in the passage width direction and pivotally supported on a vertical shaft 87a so as to be horizontally rotatable. The cam 87 is rotationally driven by electric driving unit (not shown) such as a pulse motor in a coin delivering rotating direction (clockwise in FIG. 4) or reverse rotating direction (counterclockwise in FIG. 4).

A pair of projecting portions 88 is projected downward at symmetrical positions on the circumference of an edge of a lower face of the cam 87, and a pair of grooves 89 is formed between the projecting portions 88. An interval between the projecting portion 88 and the passage face 50 is formed at a dimension that the coin cannot enter. An interval between the groove 89 and the passage face 50 and the width of groove 89 between the projecting portions 88 are respectively formed at a dimension that one coin can enter.

An edge, which faces in the delivering rotating direction, of each projecting portions 88 is adapted to serve as a pressing portion 88a for pressing the circumference of the coin, which is fed from the feeding mechanism 31 and enters the groove 89, and delivering the coin to the projected portion 84 of the transporting belt 83. Additionally, an edge, which faces in a direction opposite from the delivering rotating direction, and outer circumferential face of each projecting portion 88 serve as a suppressing portion 88b for separating the succeeding coin from a coin to be delivered and keeps the succeeding coin until the next delivering timing.

A coin detecting sensor 90 for detecting the coins fed from the feeding mechanism 31 to the identifying passage 32 is disposed adjacently to the side of the feeding belt 43 of the feeding mechanism 31.

As shown in FIG. 4(a), a position, where the coin fed from the feeding mechanism 31 to the identifying passage 32 enters one of the grooves 89 of the cam 87 and stops in a state of coming into contact with one of the suppressing portions 88b, is set as a constant position of the cam 87, and the cam 87 rotates by 180° in the delivering rotating direction (clockwise in FIG. 4) at a timing that the coin can be delivered to the projected portion 84 in accordance with a position of the projected portion 84 of the transporting belt 83, and feeds the coin in one of the grooves 89 to the identifying passage 32. The succeeding coin fed from the feeding mechanism 31 enters the other groove 89 of the cam 87 and stops in a state of coming into contact with the other suppressing portion 88b, that is, stops at the next constant position, and stands by for the next delivering operation.

Here, when the cam 87 rotates as shown in FIG. 4(b) from the constant position shown in FIG. 4(a), the pressing portion 88a of the cam 87 comes into contact with the coin, the coin is clamped between the pressing portion 88a and the pulling-over lever 47, and the pulling-over lever 47 pressed by the cam 87 via the coin rocks outside of the passage against energization, as shown in FIG. 4(c). However, the cam 87 is rotated by a specified angle from the constant position and then temporarily stopped for a predetermined time, and thus the coin is pushed into the groove 89 of the cam 87 by energization of the pulling-over lever 47 as shown in FIG. 4(d). After the temporary stop for a predetermined time, the cam 87 rotates again to feed the coin pushed into the groove 89 to the identifying passage 32, and stops at the constant position after rotating by 180°.

The groove 89 of the cam 87 is formed so as to have a dimension that a coin having a maximum diameter can enter. Accordingly, in the case where coins to be processed contain 500 yen coins having the maximum diameter, 1 yen coins having a minimum diameter and the like, if a fixing guide is provided instead of the pulling-over lever 47 shown in FIG. 4(c), there is a possibility that two 1 yen coins each having the minimum diameter enter the groove 89 of the cam 87 and the cam 87 locks the 1 yen coins by biting them between itself and the fixing guide. On the other hand, if the pulling-over lever 47 is used, only one 1 yen coin having the minimum diameter enters the groove 89 of the cam 87. Further, if the cam 87 is temporarily stopped in the middle of rotation, the coin can be reliably pushed into the groove 89 of the cam 87 by the pulling-over lever 47 and can be fed. Accordingly, the coin can be prevented from being bitten, and stably fed.

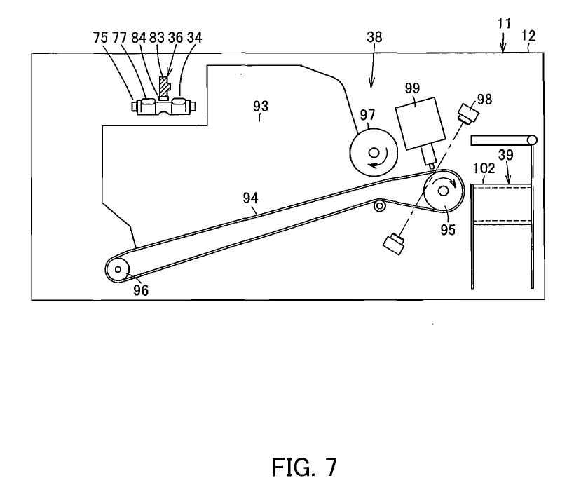

Additionally, as shown in FIG. 7, each accommodating and ejecting portion 38 has an accommodating portion 93 for accommodating the coins sorted on the sorting passage 34 and dropped without being aligned. An ejecting belt 94 constituting a bottom of the accommodating portion 93 is disposed along the machine body width direction.

The ejecting belt 94 is an endless flat belt and suspended so as to be tilted upward from the left side, upstream side in an ejecting direction, to the right side, downstream side, by a plurality of rollers containing both end rollers 95, 96 each pivotally supported on a horizontal shaft.

A reverse rotating roller 97 is provided across a gap, through which only one coin can pass, for the upper side of the end of the ejecting belt 94 in the coin ejecting direction. The reverse rotating roller 97 rotates in a direction opposite from the coin ejecting direction of the ejecting belt 94, and aligns non-aligned coins, which are to be ejected by rotation of the ejecting belt 94 in the coin ejecting direction, on the ejecting belt 94 by one layer and one line and ejects them.

Ejection detecting unit 98 and a stopper 99 are disposed on the end side, relative to the reverse rotating roller 97, of the ejecting belt 94 in the ejecting direction, the unit 98 for detecting the number of coins to be ejected from the end of the ejecting belt 94, the stopper 99 for forcibly stopping ejection of the succeeding coin at the time when coins are ejected by the necessary number of coins.

Additionally, as shown in FIGS. 1, 6 and 7, the transporting unit for dispensing 39 has a dispensing and transporting belt 102 which is stretched, in the longitudinal direction, aside of all the accommodating and ejecting portions 38 in the coin ejecting direction, and the coins ejected from each accommodating and ejecting portion 38 are placed on the dispensing and transporting belt 102 and transported forward. A reverse rotating roller 103 is provided across a gap, through which only one coin can pass, from the upper side of the front end of the dispensing and transporting belt 102 in the coin transporting direction. The reverse rotating roller 103 rotates in a direction opposite from the coin transporting direction of the dispensing and transporting belt 102, and aligns non-aligned coins on the dispensing and transporting belt 102 to be fed forward by rotation of the dispensing and transporting belt 102 by one layer and one line and feeds them.

A passage plate 104 is disposed between the front end of the dispensing and transporting belt 102 and the coin dispensing port 20, and a releasing belt 105 for transporting the coins fed by the dispensing and transporting belt 102 and releasing them into the coin dispensing port 20 is disposed above the passage plate 104.

Dispensing detecting unit 106 for detecting the number of coins to be dispensed into the coin dispensing port 20 is disposed in the transporting unit for dispensing 39.

Additionally, control unit 111 for communicating with the POS cash register and controlling the coin depositing and dispensing machine is disposed in the body unit 13.

The control unit 111 has the following functions regarding control of the LED 22 of the light emitting unit 21.

The control unit 111 has a function of making the LED 22 of the light emitting unit 21 emit light in a different light emission form for each handling type of the coins dispensed into the coin dispensing port 20, that is, a function of making the LED 22 emit light having a different color for each handling type of coins.

For example, the LED 22 is turned on in green in the case where the coins to be paid are normally dispensed, and the LED 22 is turned on in red in the case where the rejected coin or error return coin is dispensed. A turn-on timing of the LED 22 is a point of time when the dispensing detecting unit 106 detects each last coin of the coins to be paid, rejected coins and error return coins and the coins are dispensed into the coin dispensing port 20.

The control unit 111 has a function of changing the LED 22 from turning-on to flashing after a lapse of a predetermined time, for example, 20 seconds, from the turning-on of the LED 22. Moreover, in the case where the coin dispensed into the coin dispensing port 20 is a rejected coin or an error return coin, the LED 22 may be flashed from the beginning.

Additionally, the control unit 111 has the following functions regarding processing of the rejected coin.

The control unit 111 has a function of driving the transporting unit for dispensing 39 when a rejected coin is generated in the case where the rejection box detecting unit 70 does not detect the rejection box 64.

The control unit 111 has a function of driving the transporting unit for dispensing 39 when a rejected coin is generated in the case where a deposit counting mode is set for, after an operator put coins to be deposited, which are received from a customer, into the coin depositing and dispensing machine so that the coins are identified, sorted and accommodated, dispensing change corresponding to a difference between identified deposited money and a purchase price.

The control unit 111 has a function of performing control in a mode pre-selected from a rejected coin accommodating mode for accommodating, when a rejected coin is generated, the rejected coin into the rejection box 64 and a rejected coin returning mode for driving the transporting unit for dispensing 39 when a rejected coin is generated, in the case where a change machine mode is set for, after the operator inputs a deposit amount of money, which is received from a customer, into the POS cash register and coins to be paid as change corresponding to a difference between deposited money and a purchase price are dispensed from the coin depositing and dispensing machine, receiving coins to be deposited into the coin depositing and dispensing machine, identifying, sorting and accommodating them.

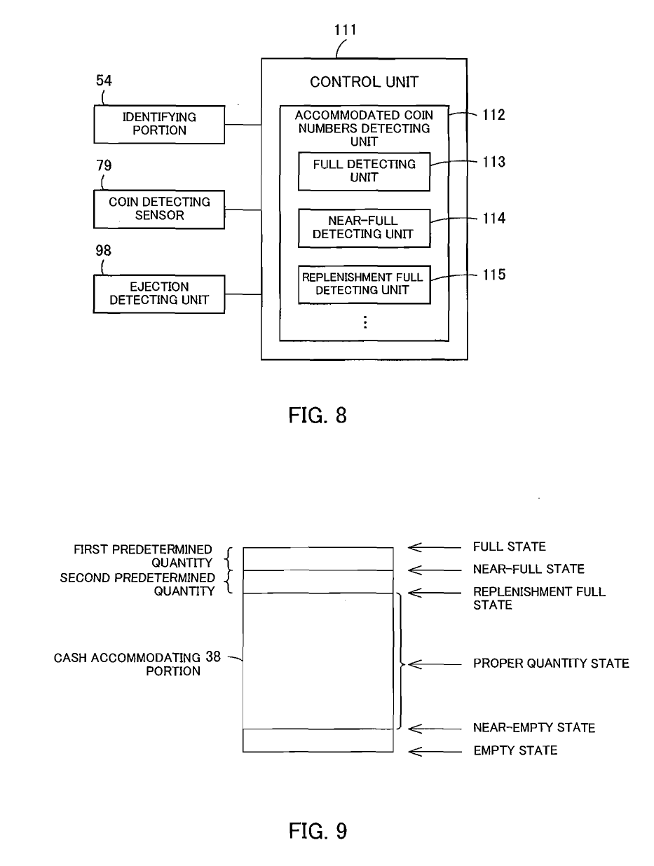

Additionally, as illustrated in FIG. 8, the control unit 111 has the following function regarding management of the cash quantity of the accommodating and ejecting portion 38.

Regarding the management of the cash quantity of the accommodating and ejecting portion 38, the control unit 111 has accommodated coin numbers detecting unit 112 for detecting the number of coins (balance) accommodated in each denomination-specific accommodating and ejecting portion 38 based on identification of the denomination by the identifying portion 54, detection by each coin detecting sensor 79 for checking the sorting of coins to each accommodating and ejecting portion 38 and detection by each ejection detecting unit 98 for detecting the number of coins to be ejected from each accommodating and ejecting portion 38.

With use of the accommodated coin numbers detecting unit 112, as illustrated in FIG. 9, the control unit 111 includes: full detecting unit 113 for detecting a full state where the accommodating and ejecting portion 38 is filled with coins; near-full detecting unit 114 for detecting a near-full state where the cash quantity of the accommodating and ejecting portion 38 is less than that in the full state by a first predetermined quantity; and replenishment full detecting unit 115 for detecting a replenishment full state, where the cash quantity of the accommodating and ejecting portion 38 is less than that of the near-full state by a second predetermined quantity, in replenishing the accommodating and ejecting portion 38 with cash, and further includes near-empty detecting unit and empty detecting unit for detecting near-empty and empty of cash in the accommodating and ejecting portion 38 respectively.

The control unit 111 executes near-full state control for rejecting depositing reception when the near-full detecting unit 114 detects the near-full state, and executes replenishment full state control for rejecting replenishment of the accommodating and ejecting portion 38 with cash when the replenishment full detecting unit 115 detects the replenishment full state at the time of replenishment.

The first and second predetermined quantities each corresponds to the quantity of cash capable of being accommodated in the cash accommodating portion in one process, and, for example, about ten coins for each denomination. Alternatively, regarding the first and second predetermined quantities, for example, each number of 1 yen coins, 10 yen coins and 100 yen coins (denomination having number “1”) is twice or more as that of 5 yen coins, 50 yen coins and 500 yen coins (denomination having number “5”), or the number of coins of the denomination having number “1” is ten, and that of the denomination having number “5” is about five.

Additionally, the control unit 111 has the following functions regarding a collecting process of coins.

The control unit 111 has accommodated coin numbers detecting unit for detecting the number of coins accommodated in each denomination-specific accommodating and ejecting portion 38 based on the identification by the identifying portion 54 and the detection by each coin detecting sensor 79 and each ejection detecting unit 98.

The control unit 111 has a function of, in an all coins collecting process for ejecting all the coins from the denomination-specific accommodating and ejecting portions 38, transporting them into and collecting them from the coin dispensing port 20, executing a first collecting operation for successively driving only a predetermined number of, for example, two, denomination-specific accommodating and ejecting portions 38, and then executing a second collecting operation for simultaneously driving all the denomination-specific accommodating and ejecting portions 38.

The control unit 111 has a function of, based on the number of coins accommodated in each denomination-specific accommodating and ejecting portion 38, making the denomination-specific accommodating and ejecting portion 38 eject the coins so that the number of the accommodated coins are the same as a predetermined number of remaining coins, for example, a few coins, and collecting them, in the first collecting operation. Additionally, the control unit 111 has a function of, in the second collecting operation, driving all the denomination-specific accommodating and ejecting portions 38 for detection of the remaining coins for a predetermined time even after all the coins are collected from all the denomination-specific accommodating and ejecting portions 38, for example, a function of repeating normal rotation (rotation in the ejecting direction) and reverse rotation (rotation in a reverse ejecting direction) of the ejecting belt 94 by a predetermined number of times.

The control unit 111 has a function of temporarily stopping ejection of the coins from the accommodating and ejecting portions 38 when the number of coins detected by all the ejection detecting unit 98, the coins to be ejected from the accommodating and ejecting portions, is not less than the number of coins detected by the dispensing detecting unit 106, the coins to be dispensed into the coin dispensing port 20 from the transporting unit for dispensing 39, by a predetermined number of coins. Additionally, the control unit 111 has a function of restarting the ejection of the coins from the accommodating and ejecting portions 38 when the number of coins to be ejected is not more than the number of coins to be dispensed by a predetermined number of coins.

Next, operation of the coin depositing and dispensing machine of the present embodiment will be described.

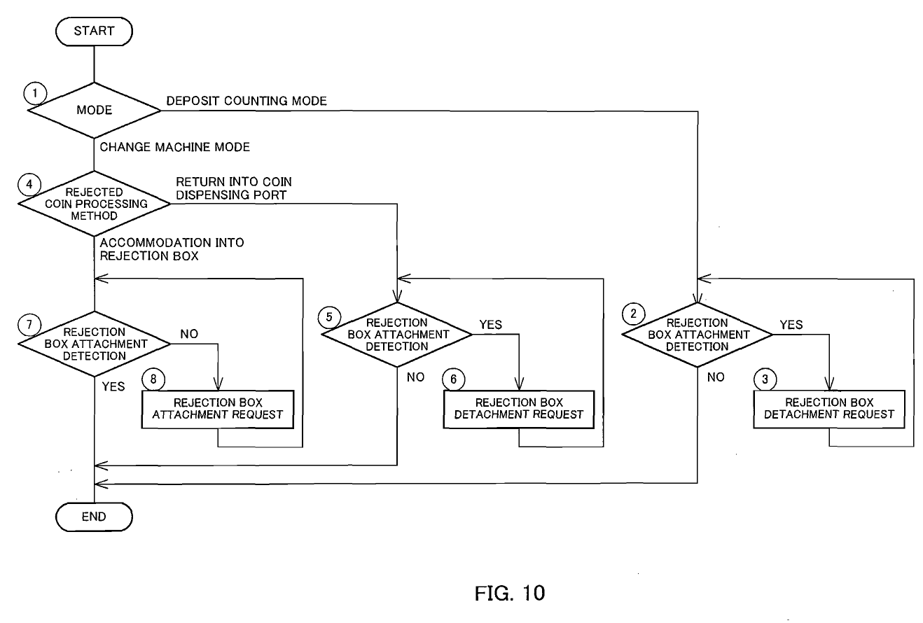

First, a setting of a mode of the coin depositing and dispensing machine will be described with reference to a flow chart in FIG. 10.

Either deposit counting mode or change machine mode is set in advance in accordance with management of the coin depositing and dispensing machine. In the case where the change machine mode is set, either rejected coin returning mode or rejected coin accommodating mode is further selected. The setting operation can be realized by the operating portion 15.

Then it is checked whether the set mode is the deposit counting mode or change machine mode (Step 1).

In the case where the deposit counting mode for returning the rejected coins into the coin dispensing port 20 is set, the rejection box detecting unit 70 checks whether the rejection box 64 is attached (Step 2). If the attachment of the rejection box 64 is detected, the display portion 16 indicates that the rejection box 64 is required to be taken out (Step 3). If the rejection box 64 is not attached or is to be taken out, a depositing process can be executed in the deposit counting mode.

On the other hand, in the case where the change machine mode is set, it is further checked which of the rejected coin returning mode for returning the rejected coins into the coin dispensing port 20 and rejected coin accommodating mode for accommodating the rejected coins into the rejection box 64 is selected as a processing method of rejected coins (Step 4).

In the case where the rejected coin returning mode for returning the rejected coins into the coin dispensing port 20 is set, the rejection box detecting unit 70 checks whether the rejection box 64 is attached (Step 5). If it is detected the rejection box 64 is attached, the display portion 16 indicates that the rejection box 64 is required to be taken out (Step 6). If the rejection box 64 is not attached or is to be taken out, the depositing process can be executed in the change machine mode.

In the case where the rejected coin accommodating mode for accommodating the rejected coins into the rejection box 64, the rejection box detecting unit 70 checks whether the rejection box 64 is attached (Step 7). If it is detected that the rejection box 64 is not attached, the display portion 16 indicates that the rejection box 64 is required to be attached (Step 8). If the rejection box 64 has already been attached or is to be attached, the depositing process can be executed in the change machine mode.

First, the depositing process will be described.

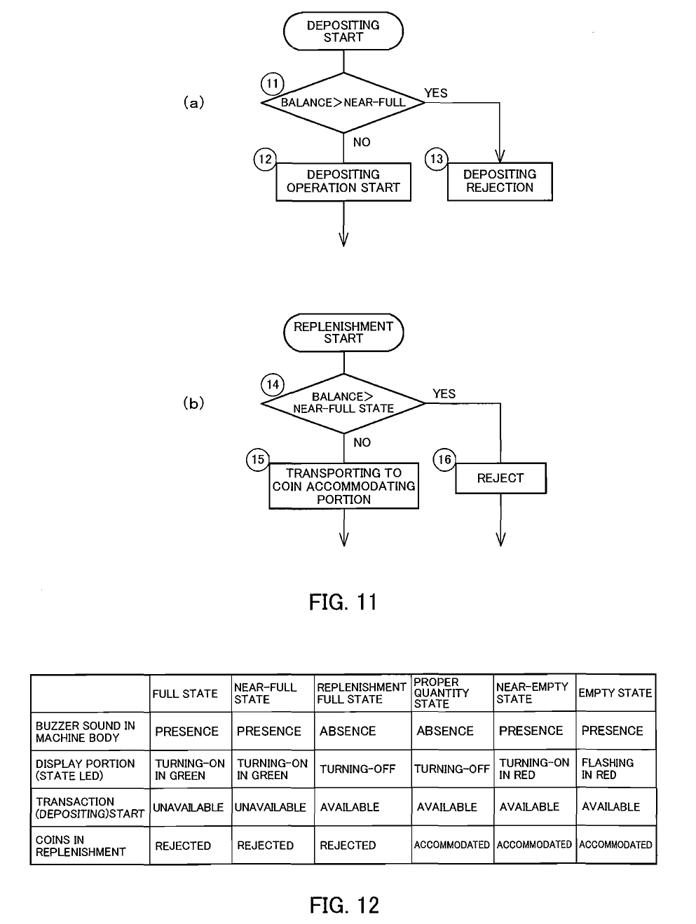

As illustrated in FIG. 11(a), the control unit 111 monitors the denomination-specific accommodated coin numbers (balance) managed by the accommodated coin numbers detecting unit 112 (Step 11). If the near-full detecting unit 114 does not detect the near-full state (accordingly, also the full detecting unit 113 does not detect the full state), the depositing reception is permitted and the depositing operation can be started (Step 12).

On the other hand, if, for example, the coin quantity of a certain denomination-specific accommodating and ejecting portion 38 is the same as that in the near-full state in the preceding depositing transaction and the near-full detecting unit 114 detects the near-full state, the depositing reception is rejected before this time depositing transaction (Step 13).

If the depositing reception is permitted, the coin put into the feeding mechanism 31 through the coin slot 14 is detected by a coin detecting sensor (not shown) of the feeding mechanism 31, and thus the feeding mechanism 31 is operated, the transporting belt 83 is rotated and the depositing operation is started.

In the feeding mechanism 31, the feeding belt 43 is rotated, the reverse rotating roller 44 is rotated in the reverse direction, and the non-aligned coins on the feeding belt 43 are aligned by one layer and one line to be fed to the delivering unit 37. In the delivering unit 37, by the above described operation of the pulling-over lever 47 and cam 87, the coins fed from the feeding mechanism 31 are fed into the identifying passage 32 one by one to be delivered to each projected portion 84 of the rotating transporting belt 83.

Additionally, in the identifying passage 32, the coins delivered by the delivering unit 37 are pushed and transported by the projected portions 84 of the transporting belt 83 to be identified by the identifying portion 54.

Coins, each of which is consequently identified as an appropriate coin, pass through the rejecting portion 58 of the eliminating passage 33 and are transported into the sorting passage 34. In the sorting passage 34, since a transporting position of the coin can be grasped based on the identification by the identifying portion 54, the detections by the coin detecting sensors 62, 79 and the transporting distance of the coin transported by the transporting belt 83, the coins, for each of which the denomination is identified by the identifying portion 54, are sorted by the corresponding denomination-specific sorting gate 77 and accommodated into the corresponding denomination-specific accommodating and ejecting portion 38.

Additionally, the rejected coin, which is consequently identified as an unidentifiable coin or the like, is eliminated through the rejection hole 59 at the rejecting gate 60 when reaching the rejecting portion 58 of the eliminating passage 33.

Here, in the case where the deposit counting mode for returning the rejected coins into the coin dispensing port 20 is set, or rejected coin returning mode for returning the rejected coins into the coin dispensing port 20 is selected as a processing method of rejected coins in the change machine mode, the rejection box 64 is not attached. Accordingly, the rejected coin eliminated through the rejection hole 59 at the rejecting gate 60 directly drops onto the dispensing and transporting belt 102.

Then, the dispensing and transporting belt 102 is rotated and the reverse rotating roller 103 is rotated in the reverse direction, and the rejected coins on the dispensing and transporting belt 102 are fed onto the passage plate 104 one by one and dispensed into the coin dispensing port 20 by the releasing belt 105.

If no coin is detected by the feeding mechanism 31 and detected by the identifying portion 54 for a predetermined time, the LED 22 of the light emitting unit 21 is turned on in red, and it is informed that the rejected coin is dispensed into the coin dispensing port 20. At the same time, the display portion 16 indicates the dispensed coin is a rejected coin.

Here, since the LED 22 turns on in red, the operator operating the coin depositing and dispensing machine can clearly recognize, even if not checking the display portion 16, that the rejected coin is dispensed into the coin dispensing port 20. Particularly, the red light of the LED 22 is irradiated to the whole coin dispensing port 20 by the coin dispensing port irradiating lens portion 25 of the lens 24 and irradiated to the coins themselves dispensed into the coin dispensing port 20, and thus the operator can clearly recognize, when taking out the dispensed coins from the coin dispensing port 20, that the dispensed coins are rejected coins. Additionally, since the red light of the LED 22 is irradiated forward by the forward irradiating lens portion 26 of the lens 24, the operator can easily notice that the rejected coins are dispensed into the coin dispensing port 20.

Additionally, it can be judged whether the rejected coins are taken out from the coin dispensing port 20 based on whether the full detecting sensor provided on the dispensing tray 18 is light-blocked. Therefore, the LED 22 is turned off if it is detected that the rejected coins are taken out.

Additionally, unless it is detected, after a predetermined time, for example, 20 seconds, from turning-on of the LED 22 in red, that the rejected coins are taken out, the LED 22 is changed from the turning-on in red to flashing in red, and it is more clearly informed that the rejected coins are dispensed into the coin dispensing port 20. Thus, forgetting to take out the rejected coins can be prevented.

Moreover, the LED 22 may be flashed in red from the beginning so that it can be more clearly recognized that the coin dispensed into the coin dispensing port 20 is a rejected coin.

Additionally, in the case where an error occurs such as a coin jam during the depositing process of coins, the coins are automatically returned into the coin dispensing port 20 as the error return coin, as described above. Also in the case where the error return coins are dispensed into the coin dispensing port 20, the LED 22 of the light emitting unit 21 is controlled, similar to the case where the rejected coins are dispensed. In this case, the LED 22 may be turned on, or flashed in a different color so that the error return coin can be distinguished from the coin to be paid and the rejected coin.

On the other hand, in the case where, in the change machine mode, the rejected coin accommodating mode for accommodating the rejected coins into the rejection box 64 is set as a processing method of rejected coins, the rejection box 64 is attached, and therefore the rejected coins eliminated through the rejection hole 59 at the rejecting gate 60 are received and accommodated into the rejection box 64.

The rejected coins accommodated in the rejection box 64 can be taken out by pulling out the body unit 13, opening the cover 67 and pulling out the rejection box 64 from the rejection box attaching portion 65.

Since the transporting unit for dispensing 39 is thus disposed under the rejecting portion 58 of the eliminating passage 33, the rejected coins can be accommodated in the rejection box 64 by arranging the rejection box 64 between the rejecting portion 58 of the eliminating passage 33 and the transporting unit for dispensing 39. If the rejection box 64 is not arranged between the rejecting portion 58 of the eliminating passage 33 and the transporting unit for dispensing 39, the rejected coins can be transported and returned into the coin dispensing port 20 by the transporting unit for dispensing 39, and, based on the presence/absence of arrangement of the rejection box 64, a processing method of rejected coins can be arbitrarily selected and changed in accordance with management.

Additionally, in the case where the rejection box detecting unit 70 detects the presence/absence of arrangement of the rejection box 64, and does not detect the rejection box 64, the transporting unit for dispensing 39, when a rejected coin is generated, is automatically driven, and can transport and return the rejected coins into the coin dispensing port 20. That is, switching can be automatically performed between drive and non-drive of the transporting unit for dispensing 39, based on the presence/absence of arrangement of the rejection box 64. In the case where the rejection box detecting unit 70 here detects the rejection box 64, needless driving is omitted, and power can be saved by not driving the transporting unit for dispensing 39 when a rejected coin is generated.

Additionally, in the case where the deposit counting mode is set, the transporting unit for dispensing 39, when a rejected coin is generated, is automatically driven, and can transport and return the rejected coin into the coin dispensing port 20. That is, the switching can be automatically performed between drive and non-drive of the transporting unit for dispensing 39, based on presence/absence of setting of the deposit counting mode.

Additionally, in the case where the change machine mode is set, either rejected coin accommodating mode or rejected coin returning mode can be arbitrarily selected and changed in accordance with the management, the rejected coin accommodating mode for accommodating, when a rejected coin is generated, the rejected coin into the rejection box 64, the rejected coin returning mode for driving the transporting unit for dispensing 39 and returning, when a rejected coin is generated, the rejected coin into the coin dispensing port 20. If the rejected coin accommodating mode is selected, the operator can be made not to touch the rejected coin. If the rejected coin returning mode is selected, the operator can check the rejected coin.

If the coin quantity of a certain denomination-specific accommodating and ejecting portion 38 is not less than that in the near-full state in this depositing transaction, the near-full detecting unit 114 detects the near-full state, and the depositing reception is rejected before the next depositing transaction.

Additionally, if the depositing reception is rejected before the depositing transaction, the coins accommodated in the accommodating and ejecting portion 38 in the near-full state are collected.

In this collecting operation, the ejecting belt 94 rotates, the reverse rotating roller 97 reversely rotates, and the non-aligned coins on the ejecting belt 94 in each accommodating and ejecting portion 38 are aligned by one layer and one line, and forwarded in the ejecting direction. In the accommodating and ejecting portion 38 in the near-full state, the stopper 99 is opened, the coins are ejected from the end of the ejecting belt 94 onto the dispensing and transporting belt 102 of the transporting unit for dispensing 39.

The ejection detecting unit 98 detects the number of coins to be ejected and subtracts it from the denomination-specific accommodated coin numbers (balance) managed by accommodated coin numbers detecting unit 112. If the denomination-specific accommodated coin numbers (balance) becomes proper, the stopper 99 is closed, the ejecting belt 94 is stopped, and the ejection of the coins is stopped.

The coins put onto the dispensing and transporting belt 102 of the transporting unit for dispensing 39 are fed onto the passage plate 104 one by one by the rotation of the dispensing and transporting belt 102 and reverse rotation of the reverse rotating roller 103, and dispensed into the coin dispensing port 20 by the releasing belt 105. The coins dispensed into the coin dispensing port 20 are taken out and collected by the operator.

The near-full state is then removed, and thus the next depositing transaction can be performed.

Since the depositing reception is thus rejected when the near-full detecting unit 114 detects the near-full state, the accommodating and ejecting portion 38 can be prevented from becoming the full state in the depositing process, that is, the depositing reception can be prevented from becoming impossible.

Although the accommodating and ejecting portion 38 sometimes becomes the full state in the depositing process, particularly, in the case where the deposited cash is directly accommodated in the accommodating and ejecting portions 38 without temporary storage, setting the near-full state allows the depositing reception to be prevented from becoming impossible in the depositing process.

Additionally, in the case where the deposit counting mode is set, the mode for dispensing the change corresponding to the difference between the identified deposited money and the purchase price, after the operator puts the coins to be deposited received from the customer into the coin depositing and dispensing machine and the coins are identified, sorted and accommodated, the depositing reception does not become impossible in the depositing process and the transaction can be completed.

Additionally, since the first predetermined quantity indicating a difference between the coin quantity in the full state and that in the near-full state is the quantity of coins capable of being accommodated in the accommodating and ejecting portion 38 in one process, one depositing process in the transaction can be reliably completed.

Moreover, the table in FIG. 12 indicates whether the depositing reception can be permitted at the start of the depositing process in accordance with each state of the coin quantity of the accommodating and ejecting portion 38, and simultaneously indicates presence/absence of a buzzer sound and a turning-on (off) condition of a state LED of the display portion 16 for displaying each state.

Next, a dispensing process will be described.

The ejecting belt 94 is rotated and the reverse rotating roller 97 is reversely rotated by, for example, a signal of dispensing command transmitted from the POS cash register, and the non-aligned coins on the ejecting belt 94 are aligned by one layer and one line and forwarded in the ejecting direction.

In the accommodating and ejecting portion 38 of denomination of coins to be dispensed, the stopper 99 is opened and the coins are ejected from the end of the ejecting belt 94 onto the dispensing and transporting belt 102 of the transporting unit for dispensing 39. The ejected coins are detected by the ejection detecting unit 98 to count the number of the coins.

In the accommodating and ejecting portion 38 of denomination of coins not to be dispensed and the accommodating and ejecting portion 38 of denomination of coins to be dispensed completing the ejecting necessary number of coins, the stoppers 99 are closed and the ejection of the coins is regulated.

Then, the dispensing and transporting belt 102 of the transporting unit for dispensing 39 is rotated and the reverse rotating roller 103 is rotated in the reverse direction, and coins to be paid on the dispensing and transporting belt 102 are fed onto the passage plate 104 one by one and dispensed into the coin dispensing port 20 by the releasing belt 105. An operation start of the transporting unit for dispensing 39 may be simultaneous with an ejecting operation start from the accommodating and ejecting portion 38, or after completion of the ejecting operation from all the accommodating and ejecting portions 38. The coins to be dispensed into the coin dispensing port 20 by the transporting unit for dispensing 39 are detected by the dispensing detecting unit 106 to count the number of the coins.

When the number of coins ejected which is detected by all the ejection detecting unit 98 corresponds to the number of coins to be dispensed which is detected by the dispensing detecting unit 106 and all the coins to be paid are dispensed into the coin dispensing port 20, the LED 22 of the light emitting unit 21 is turned on in green, and it is informed that the coins to be paid are dispensed into the coin dispensing port 20.

Since the LED 22 here turns on in green, the operator operating the coin depositing and dispensing machine can clearly recognize that the coins to be paid are dispensed into the coin dispensing port 20. Particularly, the green light of the LED 22 is irradiated to the whole coin dispensing port 20 by the coin dispensing port irradiating lens portion 25 of the lens 24 and irradiated to the coins themselves dispensed into the coin dispensing port 20, and thus the operator can clearly recognize, when taking out the dispensed coins from the coin dispensing port 20, that the dispensed coins are rejected coins. Additionally, since the green light of the LED 22 is irradiated forward by the forward irradiating lens portion 26 of the lens 24, the operator can easily notice that the coins to be paid are dispensed into the coin dispensing port 20.

Additionally, it can be judged whether the coins to be paid are taken out from the coin dispensing port 20 based on whether the full detecting sensor provided on the dispensing tray 18 is light-blocked. Therefore, the LED 22 is turned off if it is detected that the coins to be paid are taken out.

Additionally, if it is not detected, after a predetermined time, for example, 20 seconds, from turning-on in green of the LED 22, that the coins to be paid are taken out, the LED 22 is changed from the turning-on in green to flashing in green, it is more clearly informed that the coins to be paid are dispensed into the coin dispensing port 20, and thus forgetting to take out the coins to be paid can be prevented.

Next, a replenishment process will be described.

The replenishment process includes initial replenishment in the case where no coins are accommodated in the machine, and additional replenishment in the case where the coin quantity is reduced during operation. In the replenishment process, a large number of replenishment coins can be easily put into the machine by opening the cover 17 of the coin slot 14.

Additionally, in the replenishment process, similar to the depositing process, the replenishment coins put into the feeding mechanism 31 are fed to the identifying passage 32 one by one and identified by the identifying portion 54.

If the coins are each consequently identified as a normal replenishment coin, they are accommodated in denomination-specific accommodating and ejecting portions 38 by accommodating in accordance with denominations in the sorting passage 34 and replenish the portions 38. Additionally, if the fed coins are rejected coins, they are eliminated by the rejecting portion 58 and returned into the coin dispensing port 20 through the transporting unit for dispensing 39.

At this time, as illustrated in FIG. 11(b), the control unit 111 monitors whether a denomination in the replenishment full state is detected by the replenishment full detecting unit 115, based on an identification result by the identifying portion 54 and the denomination-specific accommodated coin numbers (balance) managed by the accommodated coin numbers detecting unit 112 (Step 14).

If the replenishment full detecting unit 115 does not detect the replenishment full state, the replenishment coins identified by the identifying portion 54 are transported to the sorting passage 34 and replenish the accommodating and ejecting portion 38 (Step 15).

On the other hand, if the coin quantity of a certain denomination-specific accommodating and ejecting portion 38 becomes the replenishment full state with the replenishment and the replenishment full detecting unit 115 detects the replenishment full state, replenishment of the portion 38 with the replenishment coins of the corresponding denomination, which are identified by the identifying portion 54 thereafter, is rejected. That is, the replenishment coins of the corresponding denomination are eliminated by the rejecting portion 58 and returned into the coin dispensing port 20 through the transporting unit for dispensing 39 (Step 16).

Since the replenishment of the corresponding denomination-specific accommodating and ejecting portion 38 with coins is thus rejected when the replenishment full state is detected at the time of replenishment, the accommodating and ejecting portion 38 does not become the full state. Therefore, the depositing transaction can be performed after the replenishment. Additionally, since the coin quantity in the replenishment full state is less than that in the near-full state by the second predetermined quantity, it is eliminated that the portion 38 becomes the near-full state with the depositing transaction immediately after replenishment and coins are required to be collected.

Moreover, the table in FIG. 12 indicates processing operation of coins during the replenishment according to each state of the coin quantity of the accommodating and ejecting portions 38.

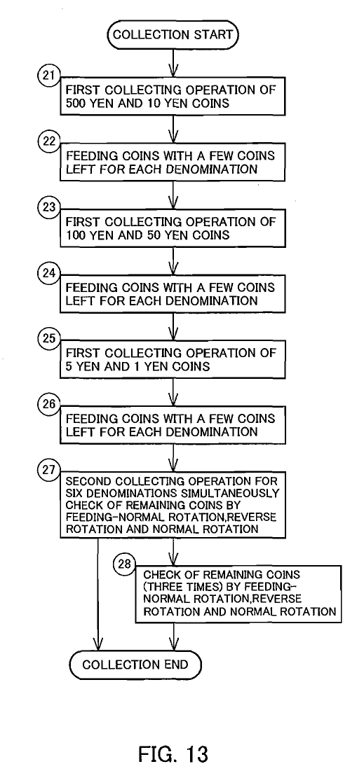

Next, the collecting process will be described with reference to a flow chart in FIG. 13.

The collecting process aims at dispensing all the coins accommodated in the accommodating and ejecting portions 38 into the coin dispensing port 20, and collecting them therefrom. After the first collecting operation for successively driving only two denomination-specific accommodating and ejecting portions 38 is executed, the second collecting operation for simultaneously driving all the denomination-specific accommodating and ejecting portions 38 is executed.

In the first collecting operation, for example, coins are simultaneously ejected and collected from the accommodating and ejecting portions 38 of two denominations, for example, 500 yen and 10 yen (Step 1).

That is, the ejecting belt 94 rotates and the reverse rotating roller 97 reversely rotates, and the non-aligned coins on the ejecting belt 94 in each accommodating and ejecting portion 38 are aligned by one layer and one line and forwarded in the ejecting direction.

The stoppers 99 are opened in the accommodating and ejecting portions 38 of the two denominations, 500 yen and 10 yen, the coins are ejected from the ends of the ejecting belts 94 onto the dispensing and transporting belt 102 of the transporting unit for dispensing 39. The ejection detecting unit 98 detects the number of coins to be ejected and subtracts it from the denomination-specific accommodated coin numbers detected by the accommodated coin numbers detecting unit of the control unit 111.

In the accommodating and ejecting portions 38 of non-collected denominations other than the two denominations, 500 yen and 10 yen, the stoppers 99 are closed and the ejection of the coins is regulated.

The dispensing and transporting belt 102 of the transporting unit for dispensing 39 is then rotated and the reverse rotating roller 103 is rotated in the reverse direction, and the coins to be collected on the dispensing and transporting belt 102 are fed onto the passage plate 104 one by one, and dispensed into the coin dispensing port 20 by the releasing belt 105. The dispensing detecting unit 106 detects the coins to be dispensed into the coin dispensing port 20 by the transporting unit for dispensing 39 to count the number of the coins.

At this time, if the number of coins to be ejected from all the accommodating and ejecting portions 38, the number being detected by the ejection detecting unit 98, is not less than the number of coins to be dispensed into the coin dispensing port 20 from the transporting unit for dispensing 39, the number being detected by the dispensing detecting unit 106, by a predetermined number of coins, the ejection of coins from the accommodating and ejecting portion 38 is temporarily stopped. Additionally, if the number of coins to be ejected is not more than the number of coins to be dispensed by a predetermined number of coins, the coins are ejected from the accommodating and dispensing port 38 again.

During the ejection of the coins from the accommodating and ejecting portions 38 of the two denominations, 500 yen and 10 yen, the control unit 111 monitors the denomination-specific accommodated coin numbers detected by the accommodated coin numbers detecting unit, and closes the stoppers 99 and regulates the ejection of the coins if each of the numbers of accommodated coins of the two denominations becomes a predetermined number of remaining coins, for example, a few coins (Step 2).

After completion of the first collecting operation regarding the two denominations, 500 yen and 10 yen, coins are simultaneously ejected and collected from the accommodating and ejecting portions 38 of two denominations, for example, 100 yen and 50 yen (Step 3).

Collection of the coins from the accommodating and ejecting portions 38 of the two denominations, 100 yen and 50 yen, is performed similar to that of the two denominations, 500 yen and 10 yen. The stoppers 99 are closed and the ejection of the coins is regulated if each of the numbers of accommodated coins of the two denominations, 100 yen and 50 yen, becomes a predetermined number of remaining coins, for example, a few coins (Step 4).

After completion of the first collecting operation regarding the two denominations, 100 yen and 50 yen, coins are simultaneously ejected and collected from the accommodating and ejecting portions 38 of two denominations, for example, 5 yen and 1 yen (Step 5).

Collection of the coins from the accommodating and ejecting portions 38 of the two denominations, 5 yen and 1 yen, is also performed similar to that of the two denominations, 500 yen and 10 yen. The stoppers 99 are closed and the ejection of the coins is regulated if each of the numbers of accommodated coins of the two denominations, 5 yen and 1 yen, becomes a predetermined number of remaining coins, for example, a few coins (Step 6).

Moreover, in the case where the full detecting sensor of the dispensing tray 18, during the collecting process, detects the dispensing tray 18 is filled with coins, the ejecting operation of the accommodating and ejecting portions 38 is temporarily stopped, the coins on the transporting unit for dispensing 39 are dispensed into the coin dispensing port 20, and then the transporting operation is stopped. The LED 22 of the light emitting unit 21 is turned on in green, thereby informing that the dispensing tray 18 is filled with coins. The operator operating the coin depositing and dispensing machine can clearly recognize, by the LED 22 turned on in green, the dispensing tray 18 is filled with coins. After the operator takes out the coins to be collected from the dispensing tray 18 and the full detecting sensor no longer detect the dispensing tray 18 is filled with coins, the collecting operations are restarted automatically or manually with the operating portion 15.

After the first collecting operation regarding all the denominations is completed, the second collecting operation is started (Step 7). That is, in driving states of the ejecting belts 94, the stoppers 99 of all the denominations are opened, and the coins remaining in the accommodating and ejecting portions 38 of all the denominations are ejected from the ends of the ejecting belts 94 onto the dispensing and transporting belt 102 of the transporting unit for dispensing 39. Each ejection detecting unit 98 detects the number of coins to be ejected and subtracts it from the denomination-specific accommodated coin numbers detected by the accommodated coin numbers detecting unit of the control unit 111.

Although, at this time, the coins are simultaneously ejected from the accommodating and ejecting portions 38 of all the denominations onto the dispensing and transporting belt 102, a small number of coins remain in each accommodating and ejecting portion 38, and therefore the coins neither pile up nor jam on the dispensing and transporting belt 102.

Additionally, in the second collecting operation, the accommodating and ejecting portions 38 of all the denominations are driven for a predetermined time for detecting the remaining coins even after the collection of all the coins from the accommodating and ejecting portions 38 of all the denominations is completed. In the check of the remaining coins, the normal rotation (rotation in the ejecting direction) of the ejecting belt 94 and reverse rotation (rotation in the reverse ejecting direction) are repeated by a predetermined number of times, and the coin detection of the ejection detecting unit 98 is monitored.

When the number of accommodated coins of all the denominations becomes zero, it is judged that no coins remain, the second collecting operation is completed and the collecting process is ended.

Additionally, if the number of accommodated coins of all the denominations does not become zero, it is judged that coins remain, and the check of the remaining coins is performed again. Accordingly, the normal rotation (rotation in the ejecting direction) of the ejecting belt 94 and reverse rotation (rotation in the reverse ejecting direction) are further repeated by a predetermined number of times, and the coin detection of the ejection detecting unit 98 is monitored (Step 8).

If the number of accommodated coins of all the denominations becomes zero here, the collecting process is normally ended. If the number of accommodated coins of all the denominations does not become zero, informing of an error or the like is performed and the collecting process is ended.

As described above, in the all coins collecting process for ejecting all the coins from the denomination-specific accommodating and ejecting portions 38, transporting them into and collecting them from the coin dispensing port 20, the second collecting operation for simultaneously driving the accommodating and ejecting portions 38 of all the denominations is performed after the first collecting operation for successively driving only the accommodating and ejecting portions 38 of two denominations. Thus, a collecting time can be shortened while the coins are prevented from piling up or jamming on the transporting unit for dispensing 39.

Additionally, the coins are collected in the first collecting operation so that the number of accommodated coins of the accommodating and ejecting portion 38 of each denomination is decreased to a predetermined number of remaining coins, and a small number of remaining coins are simultaneously ejected from the accommodating and ejecting portions 38 of all the denominations in the second collecting operation. Thus, all the coins can be efficiently collected in a short time.

Additionally, since, in the second collecting operation, the accommodating and ejecting portions 38 of all the denominations are driven for a predetermined time for detecting the remaining coins even after the collection of all the coins from the accommodating and ejecting portions 38 of all the denominations is completed, the remaining coins in the accommodating and ejecting portions 38 of all the denominations can be checked at one time, and all the coins can be collected in a short time.

Additionally, when the number of coins ejected from the accommodating and ejecting portions 38 is not less than the number of coins to be dispensed into the coin dispensing port 20 from the transporting unit for dispensing 39 by a predetermined number of coins, the ejection of the coins from the accommodating and dispensing portions 38 is temporarily stopped, and thus the coins can be prevented from piling up or jamming on the transporting unit for dispensing 39.

Moreover, in the first collecting operation, when the accommodating and ejecting portions 38 are simultaneously driven by two denominations and the number of coins accommodated in the accommodating and ejecting portion 38 of one of the two denominations becomes a predetermined number of remaining coins, the accommodating and ejecting portion 38 is stopped, and the accommodating and ejecting portion 38 of a denomination of the next order is driven. Thus, the coins are constantly ejected from the accommodating and ejecting portions 38 of two denominations, and all the coins can be efficiently collected in a short time. For example, 500 yen, 100 yen, 50 yen, 10 yen, 5 yen and 1 yen coins are collected in this order.

Additionally, the number of denominations of the accommodating and ejecting portions 38 to be driven is not limited to two, and one denomination and three denominations are applicable. In the case of one denomination, for example, 500 yen, 100 yen, 50 yen, 10 yen, 5 yen and 1 yen coins may be collected in this order. In the case of three denominations, for example, 500 yen, 100 yen and 50 yen coins may be first collected, and then 10 yen, 5 yen and 1 yen coins maybe collected.

In the thus constituted coin depositing and dispensing machine, since the light emitting unit 21 provided in the vicinity of the coin dispensing port 20 emits light in a different light emission form for each handling type of the coin dispensed into the coin dispensing port 20, the handling type of the coins dispensed into the same coin dispensing port 20 can be clearly recognized, and the coins can be prevented from being mistakenly mishandled.

Moreover, as a light emission form, color, turning-on, flashing, the speed of flashing, and the like can be cited, and anything is usable. For example, even if only one light emission color is used, turning-on, flashing, the speed of flashing or the like may be used to distinguish the handling type of the coins.

Additionally, as a cash processing machine, to which the light emitting unit capable of emitting light in different light emission forms as described above is applied, not only the coin depositing and dispensing machine but also a banknote depositing and dispensing machine are applicable. In the banknote depositing and dispensing machine, the light emitting unit is provided in the vicinity of a banknote dispensing port, and emits light of different colors in accordance with the handling type of a banknote dispensed into the banknote dispensing port. The light emitting unit may irradiate light to the banknotes themselves dispensed into the banknote dispensing port or to the whole banknote dispensing port. Alternatively, the light emitting unit may be turned on when the banknotes are dispensed into the banknote dispensing port, and may be flashed after a lapse of a predetermined time from the turning-on of the light emitting unit. Further, in the case where the banknotes dispensed into the banknote dispensing port are rejected banknotes, the light emitting unit may be flashed from the beginning. Additionally, in the case where the banknote depositing and dispensing machine has a function of returning banknotes remaining on a passage, as error return banknotes, into the banknote dispensing port to automatically remove a banknote jam caused during a depositing process of banknotes, the different handling types of banknotes dispensed into the same banknote dispensing port contains the error return banknote, and therefore the light emitting unit may emit light in a different light emission form in the case where the banknote dispensed into the banknote dispensing port is a banknote to be paid, rejected banknote or error return banknote.

Additionally, the coin depositing and dispensing machine of the present embodiment has the following features regarding the processing of the rejected coin.

In a conventional coin depositing and dispensing machine, coins to be deposited put into a coin slot are transported through a coin passage one by one and identified by an identifying portion, coins, each of which is consequently identified as a normal coin, are sorted and accommodated by denomination at the downstream region of the coin passage in a transporting direction, and rejected coins, which are, for example, unidentifiable, are eliminated from the coin passage. The rejected coins eliminated from the coin passage are returned into a coin dispensing port (see, for example, Japanese Laid-Open Patent Publication No. 2001-43449), or accommodated in a rejection box attachably/detachably arranged in the coin depositing and dispensing machine (see, for example, Japanese Utility Model No. 2520891).

As described above, in the conventional coin depositing and dispensing machine, the rejected coins are returned into the coin dispensing port, or accommodated in the rejection box attachably/detachably arranged in the coin depositing and dispensing machine. Therefore, after set-up of the coin depositing and dispensing machine, a processing method of rejected coins cannot be changed in accordance with the management required by a user.

Thereupon, the present invention provides a coin depositing and dispensing machine capable of arbitrarily selecting and changing a processing method of rejected coins in accordance with the management.

That is, in the coin depositing and dispensing machine including: the feeding mechanism 31 for feeding the coins put into the coin slot 14 one by one; the identifying passage 32 having the identifying portion 54 for identifying the coins fed from the feeding mechanism 31; the eliminating passage 33 which is disposed continuously to the identifying passage 32 and has the rejecting portion 58 for discharging the rejected coins identified by the identifying portion 54; the sorting passage 34 which is disposed continuously to the eliminating passage 33 and sorts the coins; the transporting unit for depositing for transporting the coins through the identifying passage 32, eliminating passage 33 and sorting passage 34; the accommodating and ejecting portions 38 each of which is disposed under the sorting passage 34, accommodates the coins sorted by the sorting passage 34 therein and can eject the accommodated coins; and the transporting unit for dispensing 39 for dispensing the coins ejected from the accommodating and ejecting portions 38 into the coin dispensing port 20, the transporting unit for dispensing 39 is disposed under the rejecting portion 58 of the eliminating passage 33, and the rejection box 64 can be attached/detached into/from the space between the rejecting portion 58 and the transporting unit for dispensing 39. Since the transporting unit for dispensing 39 is thus disposed under the rejecting portion 58 of the eliminating passage 33, the rejected coins can be accommodated in the rejection box 64 if the rejection box 64 is arranged between the rejecting portion 58 of the eliminating passage 33 and the transporting unit for dispensing 39. If the rejection box 64 is not arranged between the rejecting portion 58 of the eliminating passage 33 and the transporting unit for dispensing 39, the rejected coins can be transported and returned into the coin dispensing port 20 by the transporting unit for dispensing 39. A processing method of rejected coins can be arbitrarily selected and changed, based on the presence/absence of arrangement of the rejection box 64, in accordance with the management.

Additionally, the rejection box detecting unit 70 and the control unit 111 are provided, the unit 70 for detecting the presence/absence of arrangement of the rejection box 64, the control unit 111 for driving the transporting unit for dispensing 39 when a rejected coin is generated in the case where the rejection box detecting unit 70 does not detect the rejection box 64. As described above, in the case where the rejection box detecting unit 70 for detecting the presence/absence of arrangement of the rejection box 64 does not detect the rejection box 64, the transporting unit for dispensing 39 is automatically driven when a rejected coin is generated, and the rejected coin can be transported and returned into the coin dispensing port 20 by the transporting unit for dispensing 39. That is, the switching can be automatically performed between drive and non-drive of the transporting unit for dispensing 39, based on the presence/absence of arrangement of the rejection box 64.

Additionally, the control unit 111 is provided, the control unit 111 for driving the transporting unit for dispensing 39 when a rejected coin is generated in the case where the deposit counting mode is set, the mode for dispensing change, as the need arises, based on the identification result after the coins to be deposited are received, identified, sorted and accommodated. In the case where the deposit counting mode is thus set, the transporting unit for dispensing 39 is automatically driven when a rejected coin is generated, and the rejected coin can be transported and returned into the coin dispensing port 20 by the transporting unit for dispensing 39. That is, the switching can be automatically performed between drive and non-drive of the transporting unit for dispensing 39, based on the presence/absence of setting of the deposit counting mode.

Additionally, the control unit 111 is provided, the control unit 111 for performing control in a mode pre-selected from the rejected coin accommodating mode for accommodating, when a rejected coin is generated, the rejected coin into the rejection box 64, and the rejected coin returning mode for driving the transporting unit for dispensing 39 when a rejected coin is generated, in the case where the change machine mode is set, the mode for receiving, identifying, sorting and accommodating coins to be deposited after coins to be paid corresponding to change are dispensed from the deposit amount of money inputted as the need arises. In the case where the change machine mode is thus set, either rejected coin accommodating mode for accommodating, when a rejected coin is generated, the rejected coin into the rejection box 64, or rejected coin returning mode for driving the transporting unit for dispensing 39 when a rejected coin is generated can be arbitrarily selected and changed in accordance with the management.

Next, the following features are provided in the present embodiment regarding the management of the cash quantity of the accommodating and ejecting portion 38. Moreover, since a cash quantity managing method of the accommodating and ejecting portion 38 is applicable to not only the coin depositing and dispensing machine but also the banknote depositing and dispensing machine for handling a banknote as cash, the management will be described as management of the cash quantity in a cash depositing and dispensing machine.

A conventional cash depositing and dispensing machine, in a depositing process, identifies deposited cash, sorts cash, which is identified as normal cash, for each denomination and accommodates it in a denomination-specific cash accommodating portion, and dispenses the accommodated cash as change as the need arises (see, for example, Japanese Laid-Open Patent Publication No. 2001-43449). Additionally, such a cash depositing and dispensing machine, in order to prevent the cash from filling the cash accommodating portion, flowing over or jamming, has a function of detecting a full state where the cash accommodating portion is filled with cash, and stopping accommodating the cash into the cash accommodating portion by detection of the full state.

However, since the conventional cash depositing and dispensing machine cannot receive cash to be deposited when the cash quantity of the cash accommodating portion becomes a full state during the depositing process of cash received from the customer, the operator is required to collect the cash from the cash accommodating portion filled with the cash and restart depositing reception, and the customer must wait for a while during the operation. Additionally, if cash is replenished, in a replenishment process for replenishing the cash accommodating portion with cash, until the cash quantity of the cash accommodating portion becomes the full state, the depositing reception becomes impossible after the replenishment.

Thereupon, there is provided a cash depositing and dispensing machine capable of preventing the cash accommodating portion from becoming the full state during the depositing process, and the depositing reception from becoming impossible, and further capable of preventing the cash accommodating portion from becoming the full state at the time of replenishment, and the depositing reception from becoming impossible after the replenishment.

That is, the cash depositing and dispensing machine including the denomination-specific cash accommodating portions (accommodating and ejecting portions 38) for accommodating deposited cash for each denomination, and feeding the cash as change as the need arises, further includes: the near-full detecting unit 114 for detecting a near-full state where the cash quantity of the cash accommodating portion (accommodating and ejecting portions 38) is less than that in the full state by a first predetermined quantity; the replenishment full detecting unit 115 for detecting a replenishment full state, where the cash quantity of the cash accommodating portion (accommodating and ejecting portions 38) is less than that in the near-full state by a second predetermined quantity, in replenishing the cash accommodating portion (accommodating and ejecting portions 38) with cash; and the control unit 111 for executing near-full state control for rejecting the depositing reception when the near-full detecting unit 114 detects the near-full state, and executing replenishment full state control for rejecting the replenishment of the corresponding cash accommodating portion (accommodating and ejecting portions 38) with cash when the replenishment full detecting unit 115 detects the replenishment full state at the time of replenishment. Since the depositing reception is thus rejected by the near-full state control when the near-full detecting unit 114 detects the near-full state, the cash accommodating portion (accommodating and ejecting portions 38) can be prevented from becoming the full state and the depositing reception can be prevented from becoming impossible, during the depositing process. Additionally, since the replenishment of the corresponding cash accommodating portion (accommodating and ejecting portions 38) with cash is rejected by the replenishment full state control when the replenishment full state is detected at the time of replenishment, the cash accommodating portion (accommodating and ejecting portions 38) can be prevented from becoming the full state and the depositing reception can be prevented from becoming impossible after the replenishment.

Additionally, the deposited cash is directly accommodated in the cash accommodating portion (accommodating and ejecting portion 38) without temporary storage. In the case where the deposited cash is thus directly accommodated in the cash accommodating portion (accommodating and ejecting portion 38) without the temporary storage, the cash accommodating portion (accommodating and ejecting portion 38) sometimes becomes the full state during the depositing process or replenishment process. However, setting of the near-full state or replenishment full state can prevent the depositing reception from becoming impossible.

Additionally, the first and second predetermined quantities each corresponds to the quantity of the cash which can be accommodated in the cash accommodating portion (accommodating and ejecting portion 38) in one process. Since the first and second predetermined quantities each thus corresponds to the quantity of the cash which can be accommodated in the cash accommodating portion (accommodating and ejecting portion 38) in one process, the one process can be reliably completed.

Additionally, the first and second predetermined quantities of the denominations each having number “1” are set so as to be twice or more as those of the denominations each having number “5.” Since the first and second predetermined quantities of the denominations each having number “1” are thus set so as to be twice or more as those of the denominations each having number “5,” the quantities can be properly set in accordance with a tendency of the denomination-specific deposited cash quantity.

Next, regarding the collecting process of coins, the coin depositing and dispensing machine of the present embodiment has the following features.

In the conventional coin depositing and dispensing machine, the coin slot, into which coins to be deposited are put, an operating portion and a display portion are disposed in an upper face of the front of a machine body, and the coin dispensing port, into which coins to be paid are dispensed, is disposed in the front of the machine body. In the depositing process, the coins put into the coin slot are, one by one, transported through the coin passage, identified by the identifying portion, and coins, each of which is identified as a normal coin, are sorted for each denomination at the downstream region of the coin passage in the transporting direction, and accommodated in a denomination-specific accommodating and ejecting portion. Additionally, in the dispensing process, coins ejected from each accommodating and ejecting portion of the denomination of coins to be dispensed are received by transporting unit for dispensing and dispensed into the coin dispensing port (see, for example, Japanese Laid-Open Patent Publication No. 2001-43449).

In such a coin depositing and dispensing machine, all the coins accommodated in the accommodating and ejecting portions of all the denominations are subjected to a collecting process for dispensing coins into and collecting the coins from the coin dispensing port. In the collecting process, in the case where the quantity of coins ejected from the accommodating and ejecting portions is more than the quantity of coins to be dispensed into the coin dispensing port by the transporting unit for dispensing when the coins are simultaneously ejected from the accommodating and ejecting portions of all the denominations, the quantity of coins on the transporting unit for dispensing increases with advance of the collecting process, and there is a possibility that the coins pile up or jam.

Therefore, in the collecting process, the coins are successively ejected from the accommodating and ejecting portions by, for example, two denominations among six denominations, and thus the quantity of the coins ejected from the accommodating and ejecting portions is made not more than the quantity of the coins to be dispensed into the coin dispensing port by the transporting unit for dispensing, the quantity of the coins on the transporting unit for dispensing does not increase with the advance of the collecting process, and the coins can be prevented from piling up or jamming.

However, a collecting time becomes long even if the coins are successively ejected from the accommodating and ejecting portions by two denominations among six denominations. Particularly, in the case where checks of remaining coins are performed by repeating normal rotation and reverse rotation of ejecting mechanisms of the accommodating and ejecting portions last in the collecting process, the remaining coins are checked every time the coins of two denominations are collected, and checked three times in total, thereby causing a long collecting time.

Thereupon, there is provided a coin depositing and dispensing machine capable of shortening the collecting time while preventing coins from piling up or jamming on the transporting unit for dispensing.

That is, the coin depositing and dispensing machine includes: the feeding mechanism 31 for feeding the coins put into the coin slot 14 one by one; the identifying passage 32 having the identifying portion 54 for identifying the coins fed from the feeding mechanism 31; the sorting passage 34 which is disposed continuously to the identifying passage 32 and sorts the coins for each denomination; the transporting unit for depositing 36 for transporting the coins through the identifying passage 32 and sorting passage 34; the denomination-specific accommodating and ejecting portions 38 which are disposed under the sorting passage 34, accommodate the coins sorted for each denomination by the sorting passage 34 therein with the coins not aligned, and can eject the accommodated coins; and the transporting unit for dispensing 39 for transporting the coins ejected from the accommodating and ejecting portions 38 into the coin dispensing port 20, and further includes the control unit 111 for, in the all coins collecting process for ejecting all the coins from the denomination-specific accommodating and ejecting portions 38 and transport them into and collect them from the coin dispensing port 20, executing the second collecting operation for simultaneously driving the accommodating and ejecting portions 38 of all the denominations after executing the first collecting operation for successively driving only the accommodating and ejecting portions 38 of a predetermined number of denominations. Since, in the all coins collecting process for ejecting all the coins from the denomination-specific accommodating and ejecting portions 38 of, transporting them into and collecting them from the coin dispensing port 20, the second collecting operation for simultaneously driving the accommodating and ejecting portions 38 of all the denominations is thus executed after the execution of the first collecting operation for successively driving only the accommodating and ejecting portions 38 of the predetermined number of denominations, the coins can be prevented from piling up or jamming on the transporting unit for dispensing 39 and, at the same time, all the coins can be collected in a short time.

Additionally, the control unit 111 includes the accommodated coin numbers detecting unit 112 for detecting the number of coins accommodated in the denomination-specific accommodating and ejecting portion 38, and, in the first collecting operation, makes the collection of coins so that the number of coins accommodated in the accommodating and ejecting portion 38 of each denomination becomes a predetermined number of remaining coins. Since, in the first collecting operation, the coins are thus collected until the number of coins accommodated in the accommodating and ejecting portion 38 of each denomination is reduced to a predetermined number of remaining coins, a small number of remaining coins are simultaneously ejected from the accommodating and ejecting portions 38 of all the denominations in the second collecting operation, and thus all the coins can be efficiently collected in a short time.

Additionally, the control unit 111, in the first collecting operation, simultaneously drives the accommodating and ejecting portions 38 by two denominations, stops, when the number of coins accommodated in the accommodating and ejecting portion 38 of one of the two denominations becomes the predetermined number of remaining coins, the accommodating and ejecting portion 38, and drives the accommodating and ejecting portion 38 of a denomination of the next order. Since, as described above, in the first collecting operation, the accommodating and ejecting portions 38 are simultaneously driven by two denominations, one of the accommodating and ejecting portions 38 of the two denominations is stopped when the number of coins accommodated in the accommodating and ejecting portion 38 becomes the predetermined number of remaining coins, and the accommodating and ejecting portion 38 of a denomination of the next order is driven, the coins are constantly ejected from the accommodating and ejecting portions 38 of the two denominations, and all the coins can be efficiently collected in a short time.

Additionally, the control unit 111, in the second collecting operation, drives the accommodating and ejecting portions 38 of all the denominations for a predetermined time for checking the remaining coins after the collection of all the coins from the coin accommodating portions of all the denominations. Since, in the second collecting operation, the accommodating and ejecting portions 38 of all the denominations are driven for the predetermined time for checking the remaining coins after the collection of all the coins from the coin accommodating portions of all the denominations, the remaining coins in the accommodating and ejecting portions 38 of all the denominations can be checked at one time, and all the coins can be collected in a short time.

Additionally, there is provided a plurality of ejection detecting unit for each detecting the number of coins to be ejected from the accommodating and ejecting portion 38, and the dispensing detecting unit 106 for detecting the number of coins to be dispensed into the coin dispensing port 20 from the transporting unit for dispensing 39, and the control unit 111 temporarily stops the ejection of coins from the accommodating and ejecting portions 38 when the number of coins to be ejected is more than the number of coins to be dispensed by a predetermined number of coins. Since the ejection of the coins from the accommodating and ejecting portions 38 is thus temporarily stopped when the number of coins to be ejected from the accommodating and ejecting portions 38 is more than the number of coins to be dispensed into the coin dispensing port from the transporting unit for dispensing 39 by the predetermined number of coins, the coins can be prevented from piling up or jamming on the transporting unit for dispensing 39.

1. A cash processing machine in which different handling types of cash containing cash to be paid and rejected cash at least are dispensed into the same cash dispensing port, the machine comprising:
light emitting unit which is provided in the vicinity of the cash dispensing port and can emit light in different light emission forms; and
control unit for making the light emitting unit emit light in a different light emission form for each handling type of cash dispensed into the cash dispensing port.

2. The cash processing machine according to claim 1, wherein
the light emitting unit can emit light of different colors as light emission forms, and
the control unit makes the light emitting unit emit light having a different color for each handling type of cash dispensed into the cash dispensing port.

3. The cash processing machine according to claim 1, wherein the light emitting unit irradiates light to cash itself dispensed into the cash dispensing port.

4. The cash processing machine according to claim 1, wherein the light emitting unit irradiates light to the whole cash dispensing port.

5. The cash processing machine according to claim 1, wherein the control unit turns on the light emitting unit when cash is dispensed into the cash dispensing port, and flashes the light emitting unit after a lapse of a predetermined time from turning-on of the light emitting unit.

6. The cash processing machine according to claim 1, wherein the control unit flashes the light emitting unit in the case where cash dispensed into the cash dispensing port is rejected cash.

7. The cash processing machine according to claim 1, wherein
error return cash is contained in different handling types of cash dispensed into the same cash dispensing port, and
the control unit makes the light emitting unit emit light in a different light emission form for each case where cash dispensed into the cash dispensing port is cash to be paid, rejected cash or error return cash.
